(19) United States
(12) Patent Application Publication
(10) Pub. No.: US 2022/0413240 A1
(43) Pub. Date: Dec. 29, 2022

(54) SUBSTRATE CAVITY WITH ALIGNMENT FEATURES TO ALIGN AN OPTICAL CONNECTOR

(71) Applicant: Intel Corporation, Santa Clara, CA (US)

(72) Inventors: Srikant NEKKANTY, Chandler, AZ (US); Pooya TADAYON, Portland, OR (US); Wesley MORGAN, Lake Oswego, OR (US); Tarek A. IBRAHIM, Mesa, AZ (US); Sai VADLAMANI, Gilbert, AZ (US)

(21) Appl. No.: 17/357,941

(22) Filed: Jun. 24, 2021

(51) Int. Cl. G02B 6/42

(52) U.S. Cl. CPC G02B 6/4292; G02B 6/4228; G02B 6/4206

(57) ABSTRACT

Embodiments described herein may be related to apparatuses, processes, and techniques related to a cavity created in a package substrate, where the surface of the substrate at the bottom of the cavity, or alignment features at the surface of the substrate at the bottom of the cavity are used to accurately align a lens of a FAU to a lens of a PIC. In embodiments, the surface of the substrate at the bottom of the cavity has additional standoff pedestal features to aid in height tolerance control of the FAU to properly align the FAU lens when attached. Other embodiments may be described and/or claimed.

### FIELD

Embodiments of the present disclosure generally relate to the field of semiconductor packaging, and in particular to optical coupling with a package.

### BACKGROUND

Continued growth in computing and mobile devices will continue to increase the demand for increased bandwidth density between dies within semiconductor packages.

### BRIEF DESCRIPTION OF THE DRAWINGS

FIG. 1 illustrates a schematic block diagram of a legacy implementation of a fiber attach unit (FAU) coupled to a topside grading coupler on a photonics integrated circuit (PIC) using a pigtail optical connector.

FIG. 2 illustrates a schematic block diagram of a legacy implementation of a V-groove based PIC-FAU assembly.

FIGS. 3A-3B illustrate a top view and a perspective view of a legacy implementation of a receptacle coupled with a substrate to align a pluggable optical connector.

FIG. 4 illustrates a side view of a block diagram of a package that includes a PIC and optical component placed within a cavity in a substrate, in accordance with various embodiments.

FIG. 5 illustrates a block diagram of a cavity in a substrate that aligns an optical connector with an on package optical component, in accordance with various embodiments.

FIG. 6 illustrates a perspective view of a block diagram of multiple cavities in a substrate to align multiple optical connectors with multiple on package optical components, in accordance with various embodiments.

FIGS. 7A-7C illustrate various side views of orientations of FAUs optically coupled with PICs, in accordance with various embodiments.

FIG. 8 illustrates an example of a process for creating a substrate cavity with alignment features for an optical connector, in accordance with various embodiments.

FIG. 9 schematically illustrates a computing device, in accordance with various embodiments.

### DETAILED DESCRIPTION

Embodiments described herein may be related to apparatuses, processes, and techniques related to a cavity created in a package substrate, where the surface of the substrate at the bottom of the cavity, or alignment features at the surface of the substrate at the bottom of the cavity are used to accurately align a lens of a FAU to a lens of a PIC. In embodiments, the surface of the substrate at the bottom of the cavity has additional standoff pedestal features to aid in height tolerance control of the FAU to properly align the FAU lens when attached.

Legacy implementations of coupling an FAU with a package typically include complex procedures that have a long assembly time, including time to verify that the FAU and/or optical fibers are is properly attached. Legacy implementations create challenges for high-volume manufacturing that result in increased package manufacturing costs.

These legacy implementations may include active alignment of a FAU to a top of a PIC silicon grated coupler. Legacy implementations may also include passive alignment solutions that include V-groove based implementations, where V-grooves are created on the edge of a PIC for placement and alignment of FAU fibers with respect to a PIC waveguide. In these implementations, optical fibers are then attached with an epoxy or other adhesive. Other legacy implementations include using a separate receptacle component to align a lens array on the package with a lens array attached to the FAU. These legacy implementations are not usable for high-volume manufacturing, have significant assembly cost, yield, and testing challenges, and separate receptacle components had cost and complexity to manufacturing.

In embodiments described herein, a cavity within the substrate replaces a receptacle component as a separate component, therefore eliminating additional process steps during manufacturing and also reducing package assembly costs and bill of materials costs. In addition, in embodiments, having a substrate cavity simplifies alignment tolerance in comparison to a separate receptacle component. Embodiments result in a tighter alignment between a FAU lens and a PIC lens.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

Various operations may be described as multiple discrete operations in turn, in a manner that is most helpful in understanding the claimed subject matter. However, the order of description should not be construed as to imply that these operations are necessarily order dependent.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

Various Figures herein may depict one or more layers of one or more package assemblies. The layers depicted herein are depicted as examples of relative positions of the layers of the different package assemblies. The layers are depicted for the purposes of explanation, and are not drawn to scale. Therefore, comparative sizes of layers should not be assumed from the Figures, and sizes, thicknesses, or dimensions may be assumed for some embodiments only where specifically indicated or discussed.

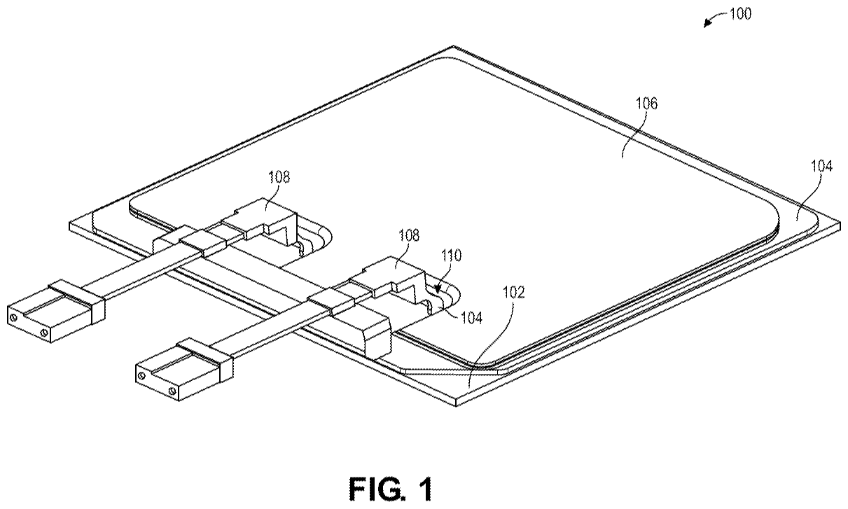

FIG. 1 illustrates a schematic block diagram of a legacy implementation of a fiber attach unit (FAU) coupled to a topside grading coupler on a photonics integrated circuit (PIC) using a pigtail optical connector. Legacy package 100 shows a substrate 102 onto which a PIC 104 is coupled, with a heatsink 106 coupled to the top of the PIC 104. Fiber attach unit (FAU) 108 is a pigtail type optical connector that attaches to a topside grating coupler 110 on the PIC 104.

In legacy implementations, the FAU 108 may be attached to the PIC 104 using an epoxy or other adhesive. In implementation, active alignment is required for the topside grating coupler 110 to FAU 108 attach, that requires an iterative process to verify correct optical alignment. This active alignment iterative process is slow, and not tenable for high-volume manufacturing package assembly and testing.

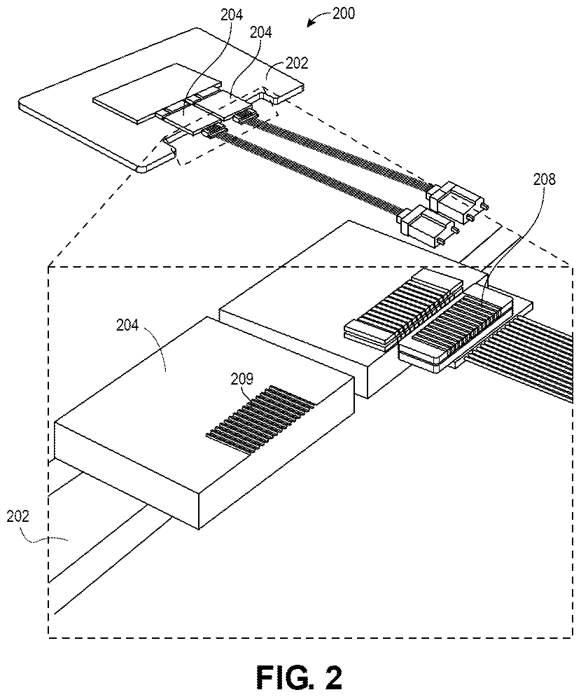

FIG. 2 illustrates a schematic block diagram of a legacy implementation of a V-groove based PIC-FAU assembly. Legacy package 200 includes a substrate 202, with PICs 204 coupled with the substrate 202. The PICs 204 overhang the substrate 202, and include multiple V-grooves 209 that overhang the substrate 202. An FAU 208 is permanently attached to the V-grooves 209 with an epoxy or was some other adhesive material, and the FAU 208 fibers are aligned with respect to the PIC 204 waveguide (not shown). Alignment using V-grooves 209 may be considered a passive alignment implementation.

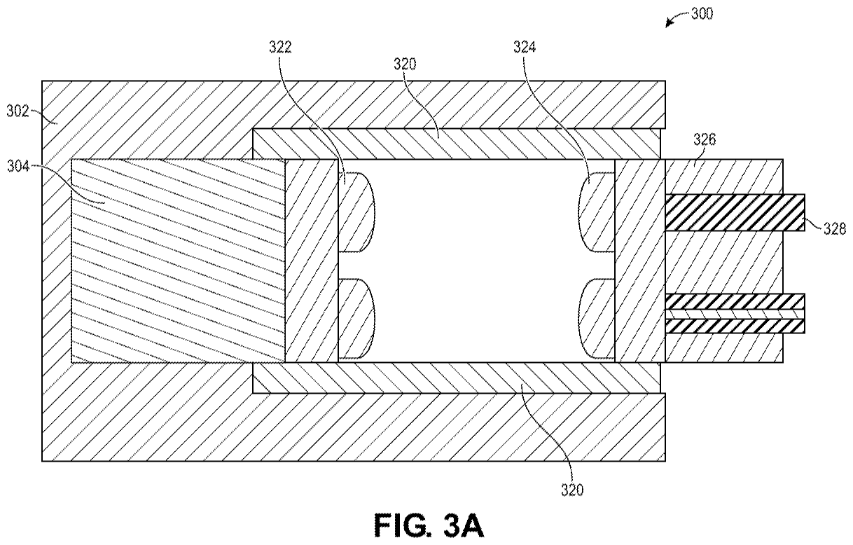

FIGS. 3A-3B illustrate a top view and a perspective view of a legacy implementation of a receptacle coupled with a substrate to align a pluggable optical connector. FIG. 3A shows package 300 with a top-down view implementation that includes a PIC 304 coupled with a substrate 302, with a receptacle 320 that is used to align a first lens array 322 that is coupled with the PIC 304, with a second lens array 324 that is coupled with a pluggable connector 326. In implementations, fibers 328 are optically coupled with the second lens array 324 and physically supported by the pluggable connector 326. The receptacle 320 is a separate component that is coupled with the PIC 304 and/or the substrate 302.

FIG. 3B shows a package 350, which is similar to package 300, but at a perspective view. The pluggable connector 326 in implementations include a recess 327, into which one or more alignment pins 325 that are a portion of the receptacle 320, may be positioned in order to align the first lens array 322 with the second lens array 324.

The use of the first lens array 322 and the second lens array 324 include spherical lenses. During operation, the first lens array 322 takes an optical beam with a smaller diameter, around 10 μm and culminates the optical beam to a larger diameter, around 100 μm. The second lens array 324 receives the larger diameter collimated optical beam. In this way, alignment tolerance is relaxed between the pluggable connector 326 and the PIC 304. In embodiments, the receptacle 320 is placed and attached to the substrate 302 using an epoxy and/or other adhesive material.

Having a separate receptacle 320 component adds to the assembly process stages of picking and placing the receptacle 320, applying an adhesive, and curing adhesive to properly couple the receptacle 320 with the substrate 302. These additional process stages increased assembly cost, and also adds to the bill of materials and adds to the overall package cost.

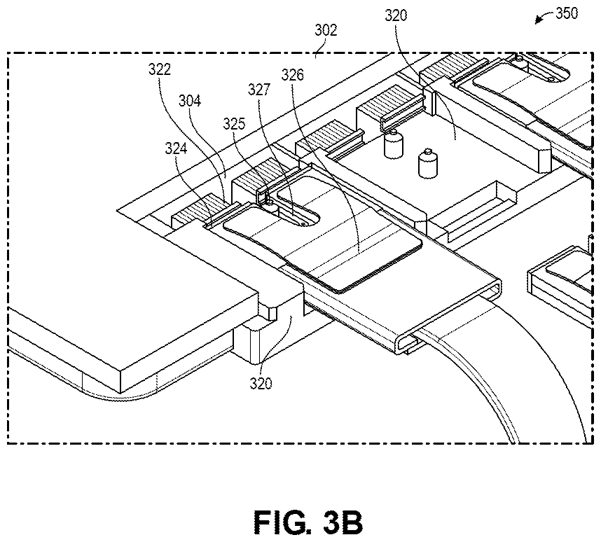

FIG. 4 illustrates a side view of a block diagram of a package that includes a PIC and optical component placed within a cavity in a substrate, in accordance with various embodiments. Package 400 shows an open cavity PIC schematic that includes a substrate 402 with a first set of bumps 404 at a top side of the substrate 402. A cavity 406 has been removed from the substrate 402, into which a PIC 408 has been inserted. The PIC 408 may be coupled to the bottom of the cavity 406 using a solder 410, or some other adhesive material. In addition, and optical components such as a lens array 423, which may be similar to lens array 322 of FIG. 3A-3B, may be also placed within the cavity 406 and also may be optically coupled with the PIC 408.

The top side of the PIC 408 may include one or more electrical connectors 414 positioned at the top of the PIC 408 and close to the substrate 402 bumps 404. An electronic integrated circuit (EIC) 418 is to be physically and/or electrically coupled with the substrate 402 and the PIC 408. In particular, EIC 418 bumps 420 are to couple with substrate 402 bumps 404, and EIC 418 bumps 422 are to couple with PIC 408 electrical connectors 414. In embodiments, the PIC is only coupled with the substrate 402 via the EIC 418. An integrated heat spreader (IHS) 424 may be thermally coupled with the substrate 402, with the EIC 418, and with other components (not shown).

Cavity 439, which may include a portion of cavity 406 that is between the lens array 423 and the edge of the substrate 403. Cavity 406 may be manufactured within the substrate 402 by laser ablating into the outline of the cavity 406, or laser ablating the entire cavity 406. During the creation of the cavity 406, various features, such as rails or grooves within an edge of the cavity 406, or features within a floor of the cavity 406 such as pedestal features discussed below, may be implemented during cavity creation, or may be implemented subsequent to cavity creation.

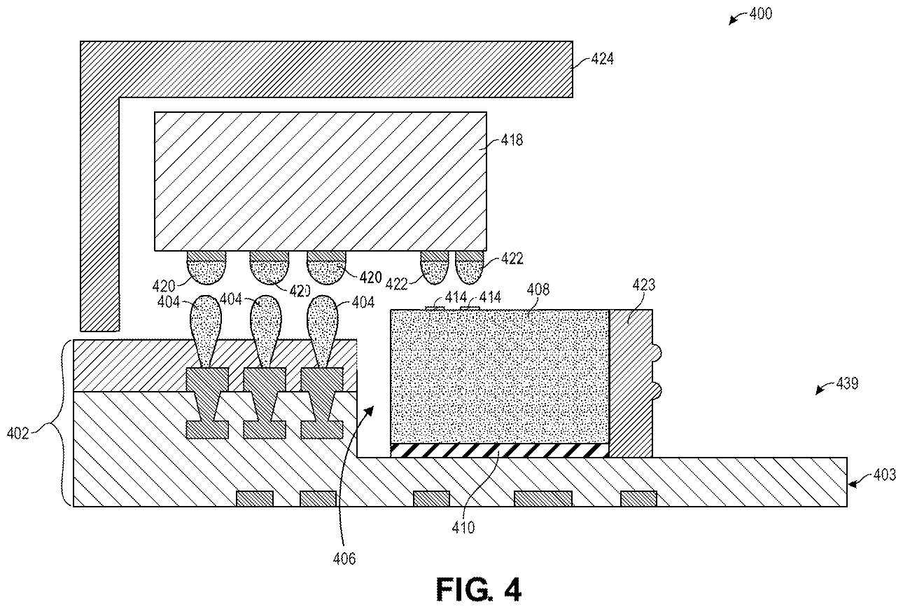

FIG. 5 illustrates a block diagram of a cavity in a substrate that aligns an optical connector with an on package optical component, in accordance with various embodiments. Package 500, which may be similar to package 400 of FIG. 4, includes a package substrate 502 with one or more cavities 539 at an edge of the substrate 502. One or more pluggable connectors 526, which may also be referred to as FAUs, are dimensioned to fit into the cavity 539 to optically couple with the PIC 508.

In embodiments, features of the cavity 539 may formed during creation, for example including ribs or railings within walls of the cavity 539 that would fit within grooves at the side of pluggable connector 526 during insertion of the pluggable connector 526 into the cavity 539. In other embodiments, grooves within walls of the cavity 539 may fit within ribs or railings at the side of pluggable connector 526 during insertion of the pluggable connector 526 into the cavity 539. In embodiments, one or more pedestals 542 may be applied to a bottom of the cavity 539. In embodiments, these pedestals 542 may be copper pedestals that have various heights and are placed in various locations within the cavity. In some embodiments, at least three pedestals 542 may be used. In embodiments, these features will optically align the optical connections included within the pluggable connector 526, within optical components included as a part of the PIC 508.

In embodiments, the cavity 539, and features of the cavity 539 may be used instead of the receptacle component 320 of FIG. 3 as a separate component to align a pluggable connector, such as pluggable connector 326, with a PIC 304. Embodiments of features of the cavity 539 are discussed in further detail below.

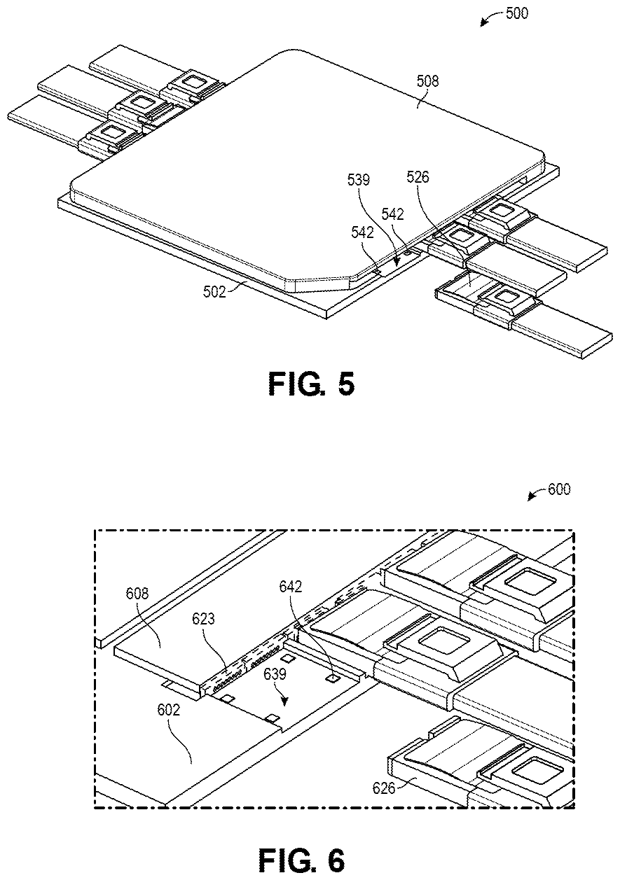

FIG. 6 illustrates a perspective view of a block diagram of multiple cavities in a substrate to align multiple optical connectors with multiple on package optical components, in accordance with various embodiments. Package 600, which may be similar to package 500 of FIG. 5, includes a substrate 602 that includes the cavity 639 that is proximate to a PIC 608. These may be similar to substrate 502, cavity 539, and PIC 508 of FIG. 5. As shown, the cavity 639 is at an edge of the substrate 602. As shown, a first lens array 623, which may be similar to first lens array for 423 of FIG. 4, may be optically coupled and/or physically coupled with the PIC 608.

Various features may be incorporated into the cavity 639 to facilitate alignment with the pluggable connector 626, which may be similar to pluggable connector 526 of FIG. 5. For example, a plurality of pedestal features 642, which may be similar to pedestal features 542 of FIG. 5, may be applied to the bottom of the cavity 639. In embodiments, the geometry of the pedestal features 642 may be varied in order to properly align the pluggable connector 626 when inserted into the cavity 639.

For example, the various pedestal features 642 may vary in height, may vary in location within a bottom of the cavity 639, or may vary in a top-down geometry. For example, as shown in FIG. 6, the pedestal features 642 have a rectangular shape. In other embodiments, the top-down geometry of the pedestal features 642 may be a circular shape, a polygonal shape, or an irregular shape. In other embodiments the pedestal features 642 may take the form of ridges, or even indentations within the bottom of the cavity 639.

In embodiments (not shown) the sides of the cavity 639 may have various features formed during creation of the cavity 639. For example, a bottom of the cavity 639 may be coplanar with a top of the substrate 602, or the bottom of the cavity 639 may be slanted from the edge of the substrate 602 toward the PIC 608 to accommodate a slanted housing of the pluggable connector 626. In other embodiments, for example, the bottom of the cavity 639 may be tilted from side to side, to accommodate a tilted housing of the pluggable connector 626.

In embodiments, pedestal features 642 may be applied to the bottom of the substrate 639 using deposition techniques that may include copper pillar or copper bump deposition, or solder deposition. In embodiments, the cavity 639 may be created using a semi-additive process. In embodiments, when the cavity 639 is being created, copper metal structures may be exposed within the substrate 602, which may serve as one or more is pedestal features 642.

In embodiments, ridges or indentations (not shown) may be created within the walls of the cavity 639, for example ridges, bump outs, piping, indentations, channels, or some other related feature that may mate with a corresponding feature on the exterior of a housing of the pluggable connector 626.

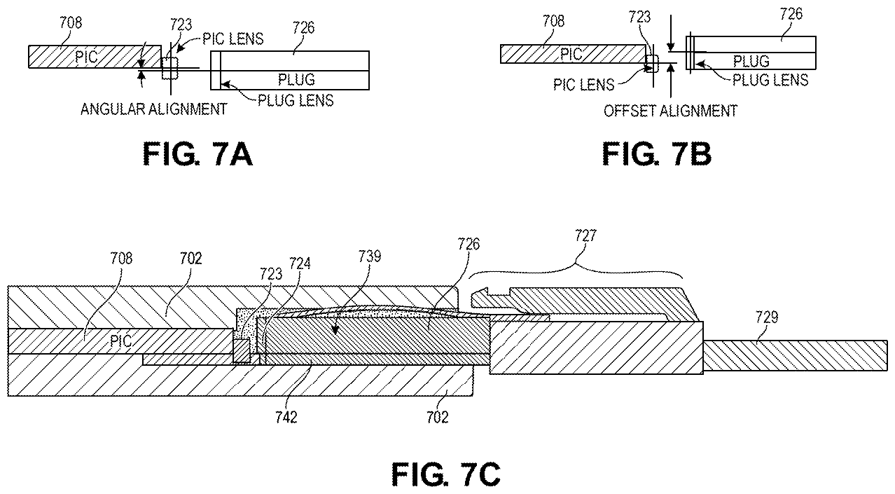

In other embodiments, the PIC 608, the lens array 623, or some other component coupled with either the PIC 608 or the lens array 623 may include a mechanical feature (not shown but discussed further with respect to FIG. 7C) that may be used to catch or lock onto a housing feature of the pluggable connector 626 when the connector is secured into the cavity 639.

FIGS. 7A-7C illustrate various side views of orientations of FAUs optically coupled with PICs, in accordance with various embodiments. FIG. 7A shows a PIC 708 that is optically coupled to a lens array 723, that may be similar to PIC 608 and lens array 623 of FIG. 6. A pluggable connector 726, which may be similar to pluggable connector 626 of FIG. 6, when inserted into a cavity such as cavity 639 of FIG. 6, may not be properly angularly aligned with the lens array 723. As a result, various features such as pedestal features 742 may be added to the bottom of the cavity 739 or incorporated into the sidewalls of the cavity 739, to properly angularly align the pluggable connector 726 with the lens array 723.

FIG. 7B shows a PIC 708 optically coupled with a lens array 723, where a plug 726 may be correctly angularly aligned, but may be offset relative to a height of the lens array 723. In this situation, a depth of the cavity 739 may need to be increased, or a height of the pedestal features 742 may need to be adjusted so that the housing of the pluggable connector 726 has a proper offset alignment.

FIG. 7C shows a PIC 708 on top of the substrate 702, with a first lens array 723 coupled with a side of the PIC 708. An optical plug 726 is inserted into a cavity 739 above the substrate 702. Pedestal features 742 may be placed at the bottom of the cavity 739 and coupled with the substrate 702 in order to align the second lens array 724 that is optically coupled with the optical plug 726 with the first lens array 723. As shown, the pluggable connector 726 may include a housing unit 727 that extends beyond the edge of the substrate 702, and is attached to an optical fiber ribbon 729.

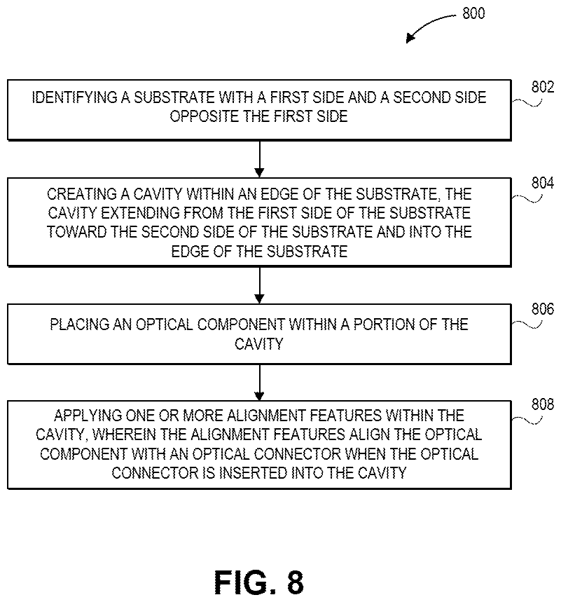

FIG. 8 illustrates an example of a process for creating a substrate cavity with alignment features for an optical connector, in accordance with various embodiments. Process 800 may be performed using the techniques, methods, systems, and/or apparatus as described herein, and particularly with respect to FIGS. 1-7C.

At block 802, the process may include identifying a substrate with a first side and a second side opposite the first side.

At block 804, the process may further include creating a cavity within an edge of the substrate, the cavity extending from the first side of the substrate toward the second side of the substrate and into the edge of the substrate.

At block 806, the process may further include placing an optical component within a portion of the cavity.

At block 808, the process may further include applying one or more alignment features within the cavity, wherein the alignment features align the optical component with an optical connector when the optical connector is inserted into the cavity.

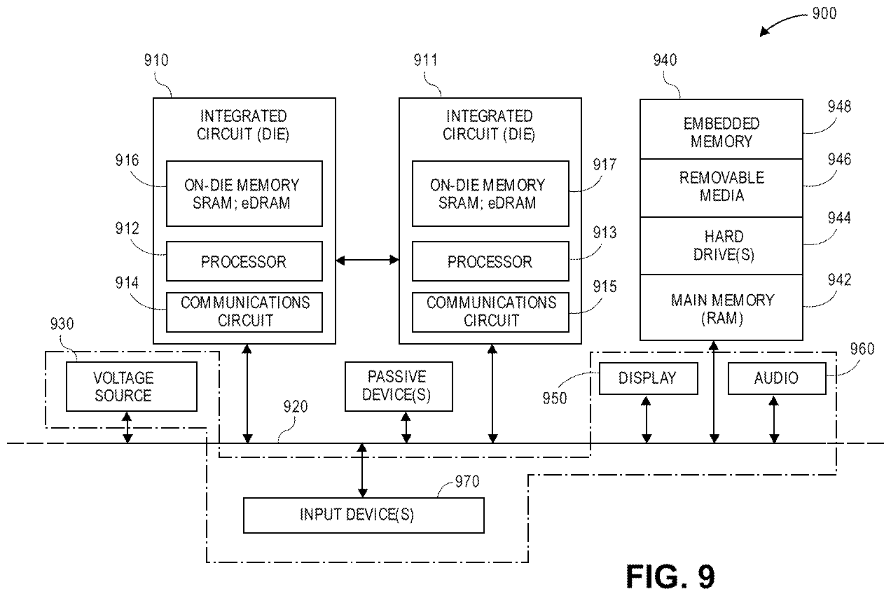

FIG. 9 is a schematic of a computer system 900, in accordance with an embodiment of the present invention. The computer system 900 (also referred to as the electronic system 900) as depicted can embody a substrate cavity with alignment features to align an optical connector, according to any of the several disclosed embodiments and their equivalents as set forth in this disclosure. The computer system 900 may be a mobile device such as a netbook computer. The computer system 900 may be a mobile device such as a wireless smart phone. The computer system 900 may be a desktop computer. The computer system 900 may be a hand-held reader. The computer system 900 may be a server system. The computer system 900 may be a supercomputer or high-performance computing system.

In an embodiment, the electronic system 900 is a computer system that includes a system bus 920 to electrically couple the various components of the electronic system 900. The system bus 920 is a single bus or any combination of busses according to various embodiments. The electronic system 900 includes a voltage source 930 that provides power to the integrated circuit 910. In some embodiments, the voltage source 930 supplies current to the integrated circuit 910 through the system bus 920.

The integrated circuit 910 is electrically coupled to the system bus 920 and includes any circuit, or combination of circuits according to an embodiment. In an embodiment, the integrated circuit 910 includes a processor 912 that can be of any type. As used herein, the processor 912 may mean any type of circuit such as, but not limited to, a microprocessor, a microcontroller, a graphics processor, a digital signal processor, or another processor. In an embodiment, the processor 912 includes, or is coupled with, a substrate cavity with alignment features to align an optical connector, as disclosed herein. In an embodiment, SRAM embodiments are found in memory caches of the processor. Other types of circuits that can be included in the integrated circuit 910 are a custom circuit or an application-specific integrated circuit (ASIC), such as a communications circuit 914 for use in wireless devices such as cellular telephones, smart phones, pagers, portable computers, two-way radios, and similar electronic systems, or a communications circuit for servers. In an embodiment, the integrated circuit 910 includes on-die memory 916 such as static random-access memory (SRAM). In an embodiment, the integrated circuit 910 includes embedded on-die memory 916 such as embedded dynamic random-access memory (eDRAM).

In an embodiment, the integrated circuit 910 is complemented with a subsequent integrated circuit 911. Useful embodiments include a dual processor 913 and a dual communications circuit 915 and dual on-die memory 917 such as SRAM. In an embodiment, the dual integrated circuit 910 includes embedded on-die memory 917 such as eDRAM.

In an embodiment, the electronic system 900 also includes an external memory 940 that in turn may include one or more memory elements suitable to the particular application, such as a main memory 942 in the form of RAM, one or more hard drives 944, and/or one or more drives that handle removable media 946, such as diskettes, compact disks (CDs), digital variable disks (DVDs), flash memory drives, and other removable media known in the art. The external memory 940 may also be embedded memory 948 such as the first die in a die stack, according to an embodiment.

In an embodiment, the electronic system 900 also includes a display device 950, an audio output 960. In an embodiment, the electronic system 900 includes an input device such as a controller 970 that may be a keyboard, mouse, trackball, game controller, microphone, voice-recognition device, or any other input device that inputs information into the electronic system 900. In an embodiment, an input device 970 is a camera. In an embodiment, an input device 970 is a digital sound recorder. In an embodiment, an input device 970 is a camera and a digital sound recorder.

As shown herein, the integrated circuit 910 can be implemented in a number of different embodiments, including a package substrate having a substrate cavity with alignment features to align an optical connector, according to any of the several disclosed embodiments and their equivalents, an electronic system, a computer system, one or more methods of fabricating an integrated circuit, and one or more methods of fabricating an electronic assembly that includes a package substrate having a substrate cavity with alignment features to align an optical connector, according to any of the several disclosed embodiments as set forth herein in the various embodiments and their art-recognized equivalents. The elements, materials, geometries, dimensions, and sequence of operations can all be varied to suit particular I/O coupling requirements including array contact count, array contact configuration for a microelectronic die embedded in a processor mounting substrate according to any of the several disclosed package substrates having a substrate cavity with alignment features to align an optical connector embodiments and their equivalents. A foundation substrate may be included, as represented by the dashed line of FIG. 9. Passive devices may also be included, as is also depicted in FIG. 9.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

The following paragraphs describe examples of various embodiments.

### EXAMPLES

Example 1 is an apparatus comprising: a substrate with a first side and a second side opposite the first side; a cavity at an edge of the substrate, the cavity extending from the first side of the substrate toward the second side of the substrate and into the edge of the substrate; and an optical component located within at least a portion of the cavity for transmitting or receiving optical signals from an optical connector when the optical connector is placed within the cavity and proximate to the optical component.

Example 2 includes the apparatus of example 1, wherein the cavity is dimensioned based upon a dimension of the optical connector.

Example 3 includes the apparatus of example 1, wherein the cavity further comprises a plurality of alignment features, wherein the alignment features align the optical component with the optical connector when the optical connector is placed within the cavity and proximate to the optical component.

Example 4 includes the apparatus of example 3, wherein at least one of the plurality of alignment features includes a pedestal extending from the bottom of the cavity toward the first side of the substrate.

Example 5 includes the apparatus of example 4, wherein the pedestal is a copper pedestal.

Example 6 includes the apparatus of example 1, wherein the optical connector includes a first lens array, and wherein the optical component includes a second lens array.

Example 7 includes the apparatus of any one of examples 1-6, wherein the optical component is physically and optically coupled with a photonic integrated circuit (PIC).

Example 8 includes the apparatus of example 7, wherein the PIC is coupled with the substrate.

Example 9 includes the apparatus of any one of examples 1-8, wherein the optical connector is a removable optical connector.

Example 10 includes the apparatus of any one of examples 1-9, wherein the optical component includes a locking feature that secures the optical connector when the optical connector is placed within the cavity and proximate to the optical component.

Example 11 is a method comprising: identifying a substrate with a first side and a second side opposite the first side; creating a cavity within an edge of the substrate, the cavity extending from the first side of the substrate toward the second side of the substrate and into the edge of the substrate; placing an optical component within a portion of the cavity; and applying one or more alignment features within the cavity, wherein the alignment features align the optical component with an optical connector when the optical connector is inserted into the cavity.

Example 12 includes the method of example 11, wherein applying one or more alignment features within the cavity further includes depositing one or more copper pedestals onto a bottom of the cavity.

Example 13 includes the method of example 11, wherein applying one or more alignment features within the cavity further includes forming one or more recesses within one or more walls of the cavity.

Example 14 includes the method of example 11, wherein the optical component includes a lens array.

Example 15 includes the method of any one of examples 11-14, further comprising: coupling a photonics integrated circuit (PIC) with the substrate, wherein the PIC is optically coupled with the optical component.

Example 16 is a package comprising: a substrate that includes: a first side and a second side opposite the first side; and a cavity at an edge of the substrate, the cavity extending from the first side of the substrate toward the second side of the substrate and into the edge of the substrate; a lens array located within at least a portion of the cavity for transmitting or receiving optical signals; a photonics integrated circuit (PIC) physically coupled with the substrate and optically coupled with the lens array; and wherein the cavity of the substrate includes a plurality of alignment features, wherein the alignment features align the lens array with an optical connector when the optical connector is placed within the cavity and proximate to the lens array.

Example 17 includes the package of example 16, wherein the plurality of alignment features includes at least one pedestal extending from a bottom of the cavity toward the first side of the substrate.

Example 18 includes the package of example 17, wherein the at least one pedestal includes copper.

Example 19 includes the package of any one of example 16-18, wherein the cavity is a first cavity, the lens array is a first lens array, the plurality of alignment features is a first plurality of alignment features, and the optical connector is a first optical connector; wherein the substrate further includes a second cavity at the edge of the substrate, the second cavity extending from the first side of the substrate toward the second side of the substrate and into the edge of the substrate; further comprising a second lens array located within at least a portion of the second cavity for transmitting or receiving optical signals; and wherein the second cavity of the substrate includes a second plurality of alignment features, wherein the second plurality of alignment features align the second lens array with the second optical connector when the second optical connector is placed within the second cavity and proximate to the second lens array.

Example 20 includes the package of example 19, wherein the PIC is a first PIC, and further including a second PIC; and wherein the second PIC is physically coupled with the substrate and optically coupled with the second lens array.

What is claimed is:

1. An apparatus comprising:
a substrate with a first side and a second side opposite the first side;
a cavity at an edge of the substrate, the cavity extending from the first side of the substrate toward the second side of the substrate and into the edge of the substrate; and
an optical component located within at least a portion of the cavity for transmitting or receiving optical signals from an optical connector when the optical connector is placed within the cavity and proximate to the optical component.

2. The apparatus of claim 1, wherein the cavity is dimensioned based upon a dimension of the optical connector.

3. The apparatus of claim 1, wherein the cavity further comprises a plurality of alignment features, wherein the alignment features align the optical component with the optical connector when the optical connector is placed within the cavity and proximate to the optical component.

4. The apparatus of claim 3, wherein at least one of the plurality of alignment features includes a pedestal extending from the bottom of the cavity toward the first side of the substrate.

5. The apparatus of claim 4, wherein the pedestal is a copper pedestal.

6. The apparatus of claim 1, wherein the optical connector includes a first lens array, and wherein the optical component includes a second lens array.

7. The apparatus of claim 1, wherein the optical component is physically and optically coupled with a photonic integrated circuit (PIC).

8. The apparatus of claim 7, wherein the PIC is coupled with the substrate.

9. The apparatus of claim 1, wherein the optical connector is a removable optical connector.

10. The apparatus of claim 1, wherein the optical component includes a locking feature that secures the optical connector when the optical connector is placed within the cavity and proximate to the optical component.

11. A method comprising:
identifying a substrate with a first side and a second side opposite the first side;
creating a cavity within an edge of the substrate, the cavity extending from the first side of the substrate toward the second side of the substrate and into the edge of the substrate;
placing an optical component within a portion of the cavity; and
applying one or more alignment features within the cavity, wherein the alignment features align the optical component with an optical connector when the optical connector is inserted into the cavity.

12. The method of claim 11, wherein applying one or more alignment features within the cavity further includes depositing one or more copper pedestals onto a bottom of the cavity.

13. The method of claim 11, wherein applying one or more alignment features within the cavity further includes forming one or more recesses within one or more walls of the cavity.

14. The method of claim 11, wherein the optical component includes a lens array.

15. The method of claim 11, further comprising: coupling a photonics integrated circuit (PIC) with the substrate, wherein the PIC is optically coupled with the optical component.

16. A package comprising:
a substrate that includes:
a first side and a second side opposite the first side; and
a cavity at an edge of the substrate, the cavity extending from the first side of the substrate toward the second side of the substrate and into the edge of the substrate;
a lens array located within at least a portion of the cavity for transmitting or receiving optical signals;
a photonics integrated circuit (PIC) physically coupled with the substrate and optically coupled with the lens array; and
wherein the cavity of the substrate includes a plurality of alignment features, wherein the alignment features align the lens array with an optical connector when the optical connector is placed within the cavity and proximate to the lens array.

17. The package of claim 16, wherein the plurality of alignment features includes at least one pedestal extending from a bottom of the cavity toward the first side of the substrate.

18. The package of claim 17, wherein the at least one pedestal includes copper.

19. The package of claim 16, wherein the cavity is a first cavity, the lens array is a first lens array, the plurality of alignment features is a first plurality of alignment features, and the optical connector is a first optical connector;
wherein the substrate further includes a second cavity at the edge of the substrate, the second cavity extending from the first side of the substrate toward the second side of the substrate and into the edge of the substrate;
further comprising a second lens array located within at least a portion of the second cavity for transmitting or receiving optical signals;
and wherein the second cavity of the substrate includes a second plurality of alignment features, wherein the second plurality of alignment features align the second lens array with the second optical connector when the second optical connector is placed within the second cavity and proximate to the second lens array.

20. The package of claim 19, wherein the PIC is a first PIC, and further including a second PIC; and
wherein the second PIC is physically coupled with the substrate and optically coupled with the second lens array.
